(19) United States
(12) Patent Application Publication
(10) Pub. No.: US 2011/0070572 A1
(43) Pub. Date: Mar. 24, 2011

(54) INTERACTIVE EDUCATION SYSTEM AND METHOD

(75) Inventors: Susan E. Miller, Norwalk, CT (US); James H. Miller, III, Mount Pleasant, SC (US); Michele E. Booth, Ridgefield, CT (US)

(73) Assignee: BEAR PRODUCTIONS LLC, Norwalk, CT (US)

(21) Appl. No.: 12/886,176

(22) Filed: Sep. 20, 2010

Related U.S. Application Data
(60) Provisional application No. 61/243,827, filed on Sep. 18, 2009.

(51) Int. Cl. G09B 7/02

(52) U.S. Cl. 434/322

(57) ABSTRACT

A digitally-based, multi-media learning center is provided for an interactive learning experience. An expert-guided digital presentation of relevant evidence-based information is provided, such as relating to medical conditions. In addition to digitally-based information, live peer-to-peer, and interpersonal interaction, including with live patients, is preferably supported to supplement the learning experience.

### CROSS-REFERENCE TO RELATED APPLICATION

This application is based on and claims priority to U.S. Provisional Patent Application Ser. No. 61/243,827, filed on Sep. 18, 2009 and entitled INTERACTIVE EDUCATION SYSTEM AND METHOD, the entire contents of which are hereby incorporated by reference.

### BACKGROUND

1. Field of the Invention

The present invention relates generally to education and, more particularly, to interactive continuing education for professionals.

2. Description of the Related Art

Changes and developments invariably occur in various industries relatively frequently. In the medical or healthcare industry, for example, new medicines, new technologies, new procedures and treatments are developed that need to be introduced to healthcare providers, such as physicians, nurses, physician assistants, emergency medical personnel or the like. The need for healthcare providers to absorb a plethora of information relating to new medicines, new procedures and treatments can be critical for the care of sick or injured patients.

Unfortunately, many patients' medical conditions and illnesses are left misdiagnosed and/or untreated, often resulting in the deterioration of the patients' health. It is recognized by the inventors that medical conditions are often partially or completely untreated due to various shortcomings. For example, a failure of physicians to broach sensitive topics with patients or to discuss patients' physical and psychiatric or psychological conditions for a sufficient length of time, often results in a missed or inaccurate diagnosis. Current shortcomings in patient healthcare also relate to insufficient medical education or training.

In general, physicians shy away from addressing medical issues in which they lack confidence, or that may be derived from knowledge, experience and mastery of a subject that is lacking. For example, embarrassment and lack of confidence have been cited as reasons why physicians fail to discuss issues in women with ovarian cancer. In addition to physicians not addressing sensitive medical issues, patients are also reluctant to raise medical concerns. Moreover and in many cases, patients are diagnosed with a condition, while very few will spontaneously request treatment.

Scheduling and perceived time constraints are also possible impediments to diagnosing medical conditions, even though certain conditions may be assessed relatively quickly, requiring only 2-3 minutes during an appointment. In addition to scheduling concerns, a general lack of awareness of simple screening tools also impede proper or effective diagnoses and treatment of medical conditions.

Another concern of healthcare providers that may impede proper or effective medical diagnoses of various conditions is financially based, and may relate to payment and insurance reimbursement. Moreover, physicians are hesitant to address certain medical concerns because a limited number of known or familiar treatments are available, or certain treatments may be “off-label.” As used herein and as known in the art, the term, off-label, refers generally to a new use for a known drug or medical treatment, which new use has not received approval from an appropriate governmental body, such as the Federal Drug Commission (“FDC”), or has not otherwise received recognized approval in the industry.

Expanding scientific and evidence-based curricula in medicine, medical school and continuing medical education are, typically, restricted to topics that are believed to be essential for all physicians. Such topics include population health, evidence-based medicine, medical ethics, sciences, financing, models of healthcare delivery, and basic clinical skills. Unfortunately, these and other topics are often insufficient for healthcare professionals to learn effective patient treatment, given the vast array of real-world conditions that physicians and healthcare professionals encounter.

The inventors recognize needs for improved education of physicians, for example, in areas relating to psychological or dysfunctional conditions. Such conditions may be identified by obtaining a patient's medical history and/or current/recent symptoms, and by identifying patients with such conditions in order to treat effectively. Too often, residents and faculty in primary care clinics do screen patients for such conditions and, accordingly, do not prescribe medications associated therewith. The inventors recognize that there may be gaps in the understanding, diagnosis, and treatment of medical conditions. Educational deficits may be present in primary care providers, as well as in specialists and other treating physicians.

Continuing education for professionals, particularly continuing medical education, is typically provided in didactic ways, such as in classrooms or by lectures provided on site at professionals' places of business. Alternatively, continuing education occurs at a public meeting place, such as in a hotel, convention center, school or other publicly accessible area. Areas for exhibits within the conference setting, such as to display new commercially available treatment options, are visited by participants between learning sessions. In a typical scenario, medical experts including those who lecture in a classroom are available to meet and speak in the conference setting. Such relatively informal conversations between experts and participants provide another means for learning.

It is recognized by the inventors that known methods of continuing medical education and other education are often not fully effective to address shortcoming, such as identified or described above. Although didactic forms of training provide information for participants and experts may make themselves available, such as on an exhibit floor, there are still many unmet healthcare issues and shortcomings, such as described above, and a lack of education is often a cause thereof.

### SUMMARY

In accordance with one or more embodiments, a system and method are provided for providing interactive education. At least one database is stored on one or more processor media that are operatively coupled to one or more processors. The database preferably includes electronic user information representing a plurality of respective persons, electronic educational content information including instructive materials associated with at least one topic, and electronic testing information including at least one question associated with the at least one topic. An education gallery that is configured with at least one computing device that is operatively connected to the one or more processors is provided with at least one panel, wherein panel(s) at least provide information associated with the educational content information.

In accordance with one or more embodiments, first electronic user information is received from a first user computing device that is associated with a first user. The one or more processors preferably selects first electronic educational content information from the electronic educational content information stored in the database that is based on at least the first user information and that is associated with a first of the at least one topic, and also selects first electronic testing information from the electronic testing information stored in the database and that is associated with the first of the at least one topic. The one or more processors preferably send to the first user computing device, via the one or more communication devices, the first electronic educational content information and the first electronic testing information. The one or more processors further preferably receive from the first user computing device, via the one or more communication devices, at least one response to at least one question associated with the first electronic testing information.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings several forms which are presently preferred, it being understood, however, that the invention is not limited to the precise arrangements and instrumentalities shown. The features and advantages of the present invention will become apparent from the following description of the invention that refers to the accompanying drawings, in which:

FIGS. 1A and 1B are perspective views of an interactive digitally enhanced learning center in accordance with an embodiment;

FIGS. 1C and 1D illustrate top plan views of example embodiments of an interactive digitally enhanced learning center;

FIGS. 2A, 2B and 2C illustrate example multimedia interactive digital educator devices in accordance with embodiments;

FIGS. 2D, 2E and 2F illustrate example screen displays provided on a digital educator device in accordance with an embodiment;

FIGS. 3A-3E illustrate an example interactive digitally enhanced learning center that is provided in a mobile learning center, and configured generally as an RV;

FIG. 4 shows an example hardware arrangement in accordance with an embodiment; and

FIG. 5 illustrates the functional elements of an information processor and/or computing devices in accordance with an embodiment.

### DESCRIPTION OF EMBODIMENTS

In accordance with the present application, a digitally based, multi-media learning center is provided for an interactive learning experience that preferably includes an expert-guided presentation of relevant evidence-based information, such as relating to disease management. In addition to digitally based information, live peer-to-peer, and interpersonal interaction, including with live patients, is preferably supported to supplement the learning experience.

Preferably, digitally based multimedia content is provided for participants, and participant-based data entry operability is also provided via one or more portable devices to receive information from participants. Thus, over the course of a learning session, data are captured and preferably used to assess participant knowledge and change in behavior. Subsequent online modules continue to assess application of learned skills into practice. Collectively, outcome data are provided that increase the accuracy of determining the center's effectiveness.

In an embodiment, an integrated learning center is provided that preferably includes communicative operability with one or more computing devices over a communication network, such as the Internet and/or a local network in near proximity or within the learning center. One or more computing devices may be provided in near proximity with an integrated learning center that send and/or receive content and information over a network. Content may be provided in custom and dynamic ways for individual participants based on, for example, the participants' respective skill levels as well as participants' knowledge/understanding of various topics. By providing an on-line environment, individual and customized learning and assessment is provided that can support thousands of participants.

As noted above, interactive digitally enhanced centers (occasionally referred to herein, generally, as “atmospheres”) for learning may include live activities, such as interactive live symposia, which may be supplemented with digitally based dynamic and/or web-based multimedia sessions. The centers may also include target-focused printed publications, journal monographs, and downloadable podcasts, which may be provided in digital and/or analog form. Thus, in an embodiment, the center provides an integration of live and virtual features for continuing medical education, such as for medical classifications, diagnoses and treatments of medical conditions and disorders, including the neurobiological background of current and investigational therapies. Clinical encounters may be preferably provided for students to identify patients who may benefit from treatment. Moreover, systems and methods disclosed herein may provide certified continuing medical education (“CME”) activities for physicians, nurses, pharmacists, and allied healthcare professionals.

The teachings herein improve the quality of patient care by targeting identified and unmet needs, including as a function of outcomes research, healthcare statistics, literature searches, and direct testimony from experts and professionals surveyed in the healthcare community. Preferably, this is accomplished as a function of a strategic program design that includes faculty development, medical direction, editorial development, project and multimedia management, graphic design services, and event planning. A unique educational programming environment is provided that is based at least in part on research, planning, development, and execution of a multitude of scientific peer-reviewed educational formats.

In an embodiment, a plurality of interactive learning centers operate independently in various locations, such as in different cities or states, which support education on one or more topics. Moreover, a single interactive learning center may operate a plurality of times over the course of days, weeks and months. Voluminous amounts of participant data may be regularly received and managed by one or more computing devices, and content representing multitudes of topics is stored and managed by the one or more computing devices. Data management relating to participants and a plurality of educational topics provides for custom learning experiences for participants. Moreover, program outcomes are evaluated based upon substantive assessments from healthcare professionals, who may participate in various activities in the interactive learning center, and/or who utilize outcome data to develop and enhance future activities. Thus, as will become apparent, an interactive network of learning centers and computing devices is provided in accordance with an embodiment, and which may be geographically located virtually anywhere in the world.

It is recognized by the inventors that clinical medical training that utilizes and/or teaches practical skills, and particularly that enables student self-assessment, is often more effective than strict knowledge-based activities, such as lecturing, reading and/or watching video. Moreover, continuing medical education or other continuing education (CME/CE) sessions that are interactive and use multiple methods of instruction, preferably for small groups and in a single discipline, are similarly more likely to result in improved learning and changed behavior. Accordingly, an interactive, case-based CME/CE course is provided herein that follows a team-based learning format that leads to a significant gain in the participants' knowledge. Improved learning is preferably measurable using pre-course data, such as from answers to questions posed to a participant prior to instruction and, thereafter, comparing the pre-course data with post-course data (e.g., answers to similar questions after participant's instruction). Additional instruction and/or test questions may be posed for one or more topics that the system determines a participant requires based thereon. This results in long-term learning that exceeds learning provided in strictly knowledge-based activities.

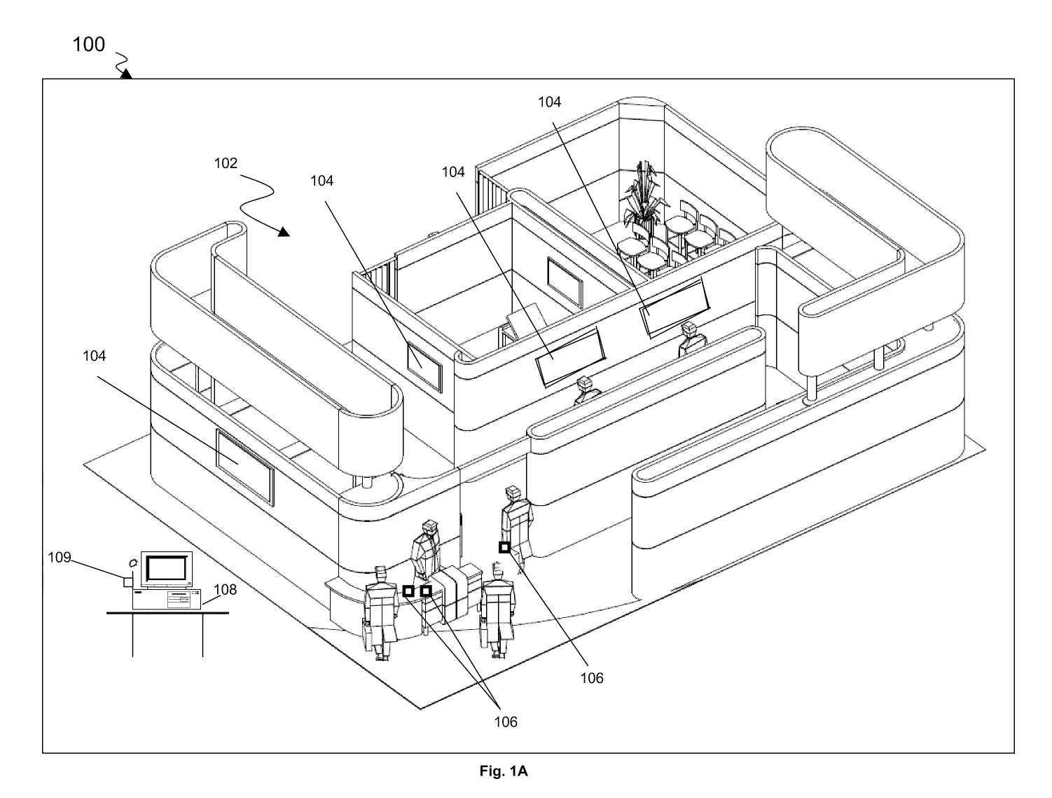

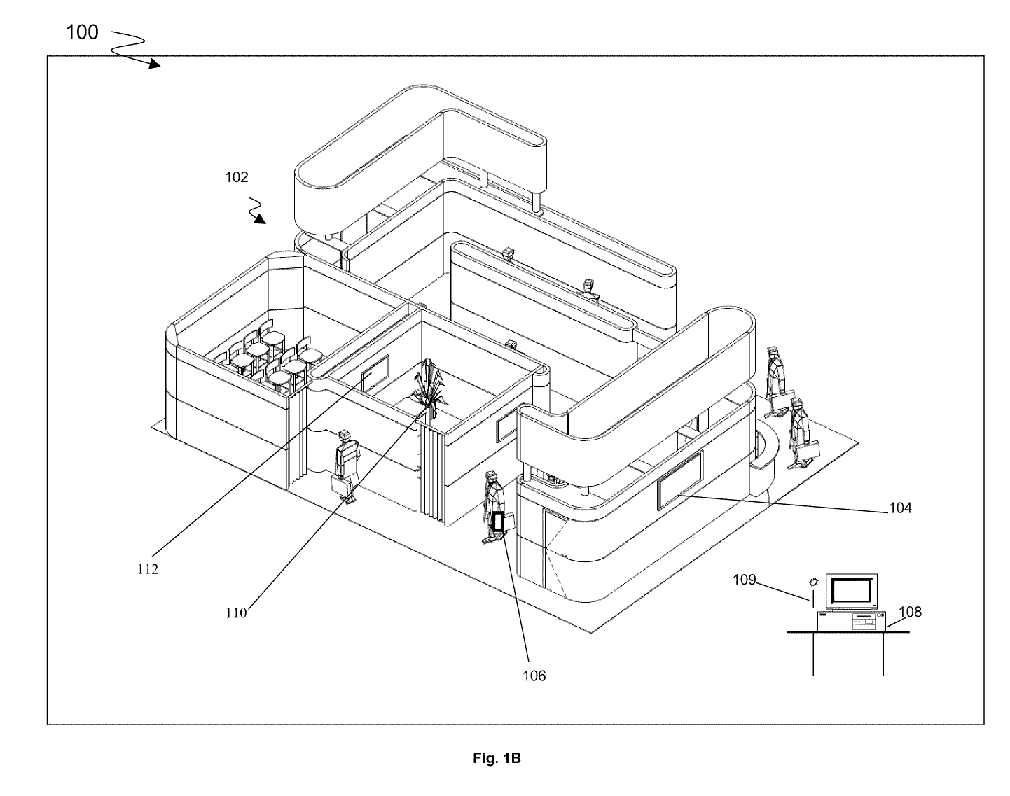

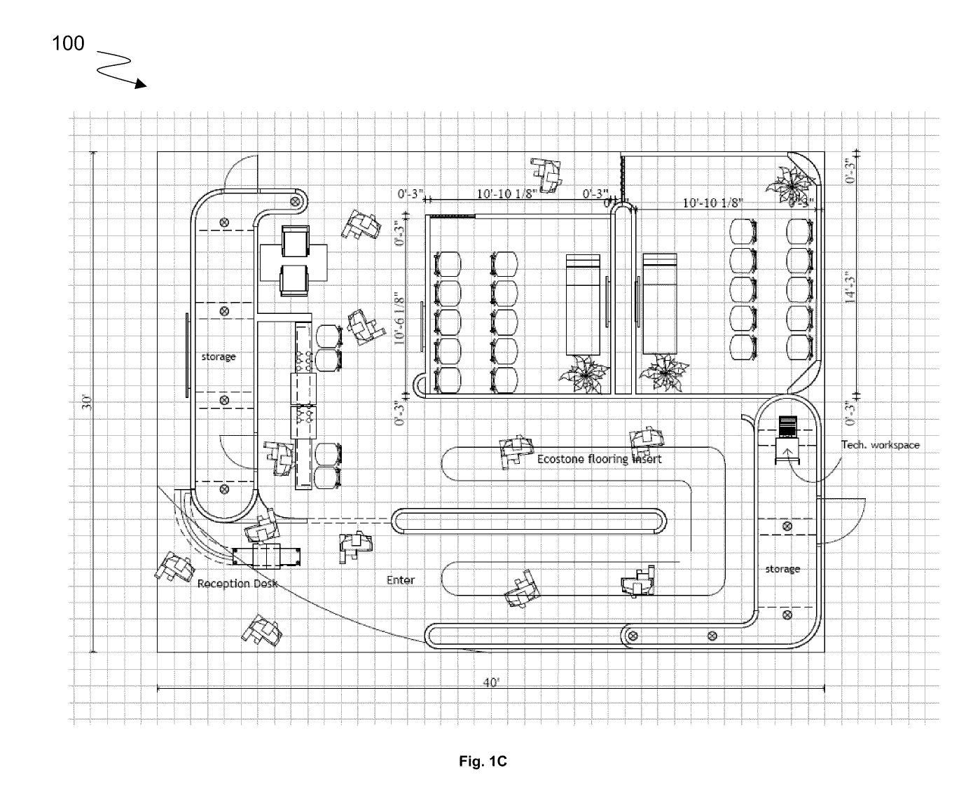

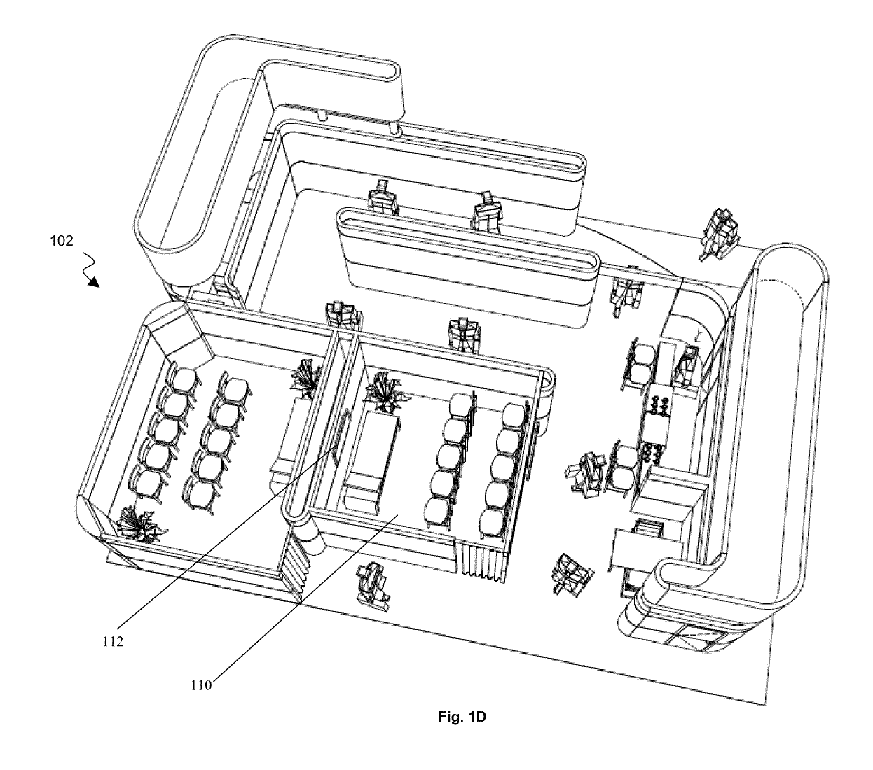

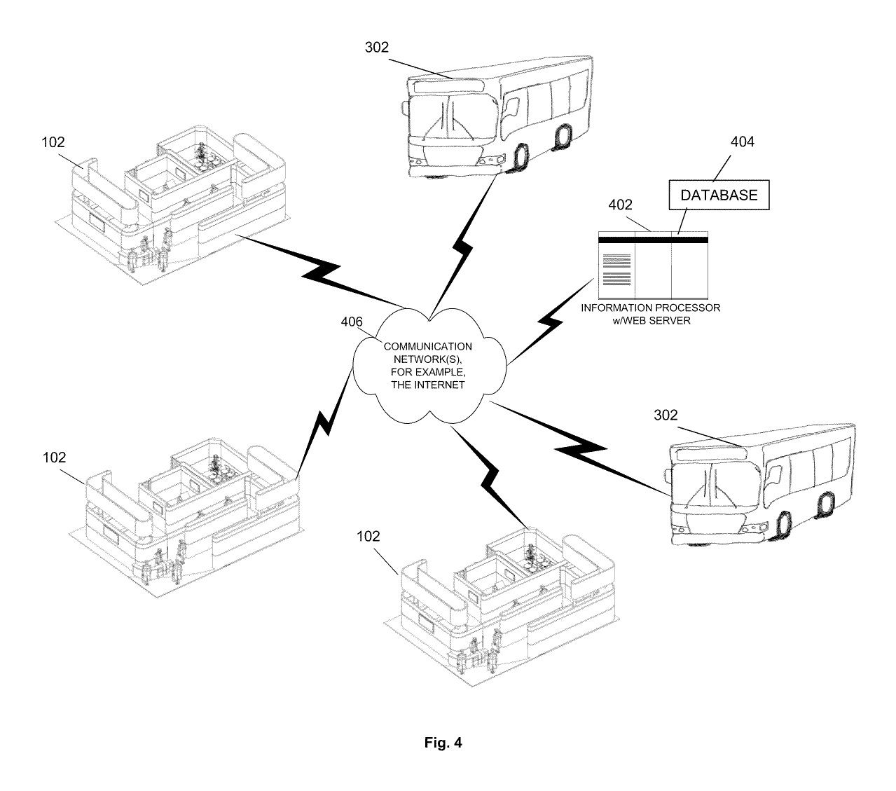

Referring now to the drawings, in which like reference numerals refer to like elements, FIG. 1A is a perspective view of an embodiment and referred to herein, generally, as interactive digitally enhanced learning center 100. As shown in the example embodiment of FIG. 1A, center 100 includes an education gallery 102 that includes stylized scientific display panels 104, and which provide content that is synchronized with an independently operated multimedia interactive guide. The multimedia interactive guide preferably includes one or more handheld multimedia digital educator devices 106, which may be configured as personal digital assistants, cellular telephones or other portable/mobile computing devices. Further, user workstation 108 is preferably provided with gallery 102, and may be configured with communication device 109 to send and receive data wirelessly to and from devices 106, as well as to send/receive content over the Internet. Moreover and/or alternatively, participants operate devices 106 to access information stored thereon or streamed thereto, including multi-media content, and further to submit information, such as in response to prompts provided by devices 106. After a participant completes a session, or any portion thereof, the information submitted by a user may be transmitted to user workstation 108, such as via a hard-wired cradle that receives device 106, or in any other suitable fashion, such as wirelessly. User workstation 108 may, thereafter, send and receive information to another computing device, such as information processor 402 (FIG. 4) over the Internet. Thus, in one or more embodiments, data may be sent/received to or from and/or stored in one or more of a plurality of devices to provide for a customized and individually tailored learning experience.

FIG. 1B illustrates another perspective view of center 100 of FIG. 1A, and shows a view that is rotated from that shown in FIG. 1A. As shown in the embodiment of FIG. 1B, education gallery 102 includes display panels 104, which provide content that is synchronized with device 106. FIG. 1B further illustrates diagnosis/treatment area 110 where participants engage in the diagnosis and treatment management of patient(s). The example treatment area 110 shown in FIG. 1B provides a location for replicating real-world experiences of a clinician. In small groups, participants may be challenged to optimize the value of each patient interaction with an appropriate work up and to make management decisions. Moreover, teaching rounds may feature a plurality of unique patient presentations. Based upon the participants' interest in the subject matter, learners may elect to visit one or more of the patients. This self-directed learning method allows learners to customize their educational experience, and is recognized by the inventors to appeal to a greater audience of participants than traditional methods of learning, such as the strict knowledge-based learning discussed above.

In an embodiment, a display screen 112 or the like is provided in diagnosis/treatment area 110, where participants engage in the diagnosis and management of patient(s). During, for example, a procedure or diagnosis, display screen 112 may prompt participants for answers to one or more questions or to comment on the procedure or diagnosis. Using device 106, the participants submit information in response to the prompts. The prompts and/or the participants' responses thereto may be discussed, such as in discussion groups, after the procedure or diagnosis session. Moreover, the reports are preferably provided for outcome data and data reports.

FIG. 1C is a top plan view of an example embodiment, including interactive digitally enhanced learning center 100 that encompasses an area of space, such as 30′×40′ located in a designated CME area. This format enables learners to actively assess and enhance their practice skills as they relate, for example, to various disease states. As noted above, participants are provided with interactive handheld multimedia digital educator device 106, which allows participants to make diagnostic and management decisions throughout the learning experience. Device 106 preferably acts as a virtual guide throughout the learning experience, beginning with a preliminary self-assessment, which sets the context for the patient visit and allows for comparison with post-activity questions.

FIG. 1D illustrates another top plan view of an example embodiment of gallery 102 and illustrates diagnosis/treatment area 110 where participants engage in the diagnosis and treatment management of patient(s). In an embodiment, a patient (simulated or real) undergoes analysis and treatment in diagnosis/treatment area 110 for a portion of time, and then temporarily leaves area 110. This enables the participants to discuss the case. When the patient returns, the condition of the patient is provided in the same or different state, as to represent or simulate the passage of time, such as two weeks or two months. Thus, participants may be involved in the care or treatment in a patient at one time, and then continue the care or treatment in a simulated passage of time.

In an embodiment, while participants are in diagnosis/treatment area 110, an expert facilitator may present priority problems to be addressed during the patient's visit, and may identify decision points to demonstrate actual learning. Participants are encouraged to engage their peers on one or more management issues presented during each patient interaction. Participants may receive immediate feedback after each decision point.

In accordance with the teachings herein, each participant may also be provided with simulated medical records, and to make decisions regarding the methods (s)he feels are most appropriate in the diagnosis and management of a particular patient. This allows for comprehensive data collection and robust outcomes analysis regarding participant performance. In one embodiment, each teaching rounds session occurring in diagnosis/treatment area 110 takes approximately 15-20 minutes to complete. At the conclusion of the visit, participants may complete an activity evaluation.

Moreover, baselines may be defined by prompting participants to answer preliminary questions before participants review or are taught about a particular case and, thereafter, to answer follow-up questions regarding the topic or case. In this way, and as noted above with regard to display panels 104, actual learning can be measured by comparing the participants' responses to the preliminary and follow-up questions.

After completing the education gallery 102, participants may enter the study break area where they may review the case histories of the patient(s) they will encounter or have already encountered during the teaching rounds, such as in diagnosis/treatment area 110. Additional materials relevant to clinical and practical skills information (referred to generally, herein, as “pearls”) may also be provided. In an embodiment, the study break area is located in the center of the activity, and is designed as a waiting area for participants who have completed education gallery 102 and are awaiting entrance into a diagnosis/treatment area 110. After completing the rounds in diagnosis/treatment area 110, participants may return to complete the program evaluation on their devices 106, and may participate in discussions at scheduled times, for example with experts on various topics. Participants may also enjoy light refreshments, and continue the learning experience through additional interaction with their peers, as well as access relevant take-home materials, such as publications, posters, and staff/patient education.

In one embodiment, interactive digitally enhanced learning center 100 programs are available for various predetermined periods of time, such as approximately seventeen (17) hours of open access during the conference. Participants may attend at their leisure during open hours.

In an embodiment, display panels 104 operate in a “plug and play” modular fashion, such that information and content is seamlessly integrated in education gallery 102 without a need for complex and custom programming for each respective education topic and session. For example, data are formatted in accordance with predefined protocols, and imported for display on panels 104 substantially automatically. Similarly, content provided on a portable multimedia device is preferably imported or otherwise integrated with device 106 in a suitable context with the content provided on panels 104. Parameters may be defined that are based at least in part on the specific content to be provided on panels 104 and/or device 106, such that device 106 operates substantially in a play mode, as audio/audio-visual content plays on device 106 for a particular amount of time (e.g., 8 minutes), and then operates substantially in an interactive mode as a number of questions (e.g., 30) are provided on device 106 at some relative time, and participants use device 106 respond and answer the questions.

In a preferred embodiment, education gallery 102 is provided with one or more stylized panels that illustrate educational information in a multi-media fashion, including in audio and graphical format (e.g., charts, graphs, pictures or the like). Moreover, live teaching rounds may be provided, and may include sessions for live patient diagnoses and management sessions, including point-of-care challenges for participants. Diagnosis and management data are preferably collected via device 106 and transmitted to the user workstation 108 substantially in real-time. Further, physicians, expert patients, and/or allied health professionals may lead teaching rounds sessions, and preferably facilitate discussions with and about real and/or simulated patients and/or simulated physicians and encourage peer-to-peer interaction. Moreover, simulated and/or actual patients and/or physicians present the patient's and or physician's perspective and may provide feedback (e.g., clinical feedback) to participants. Other features include training and preparation of faculty, facilitators, and patients (simulated by actors and/or actual) through a provision of written character descriptions and scripts, teleconferences, and pre-event rehearsals. Further, electronic syllabi may be provided, such as via an Internet web site and/or downloaded automatically to device 106. Moreover, electronic tools, resources and information to be discussed during live activity, along with copies of the panels and expert transcript/audio may be provided via the Internet web site.

In an embodiment, participants may be entitled to accredited continuing medical education credit. In an embodiment, participants claim credit that is commensurate with the extent of their participation in the activity. Moreover, accreditation for activity in accordance with the teachings herein may be for predetermined time periods, such as for one year.

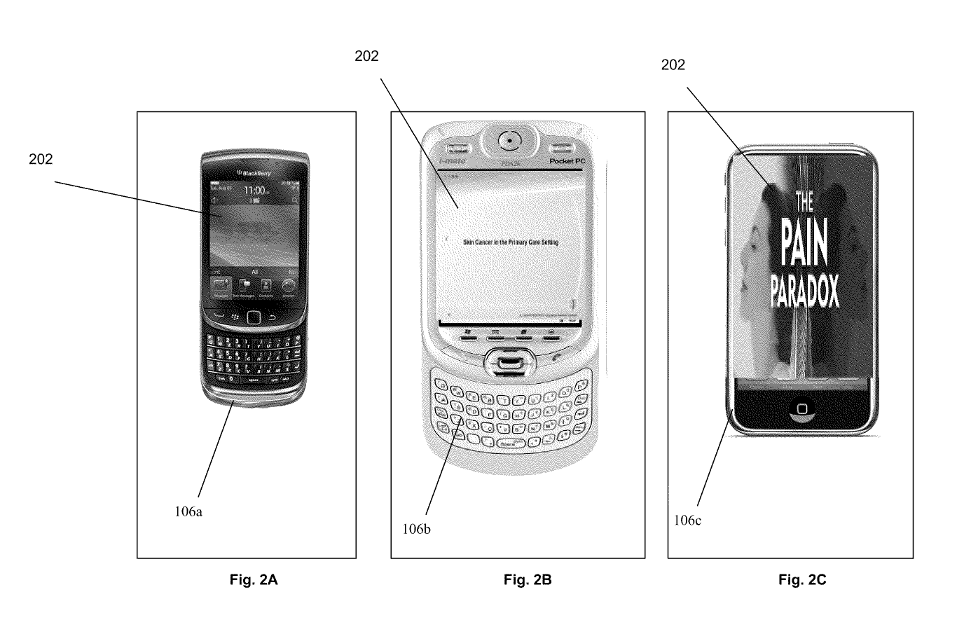

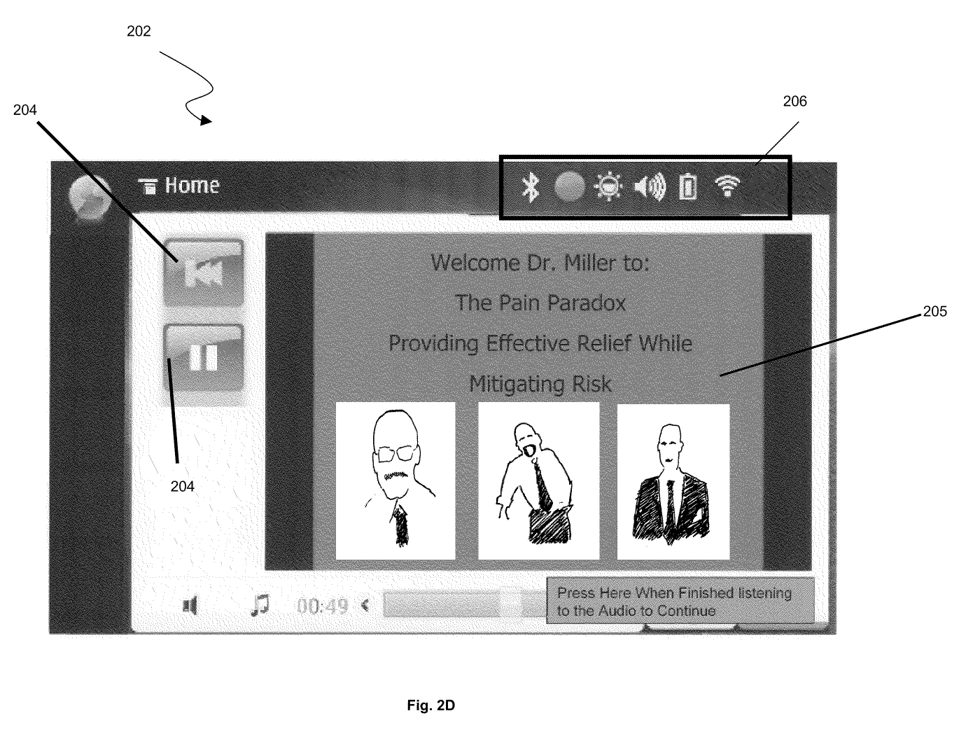

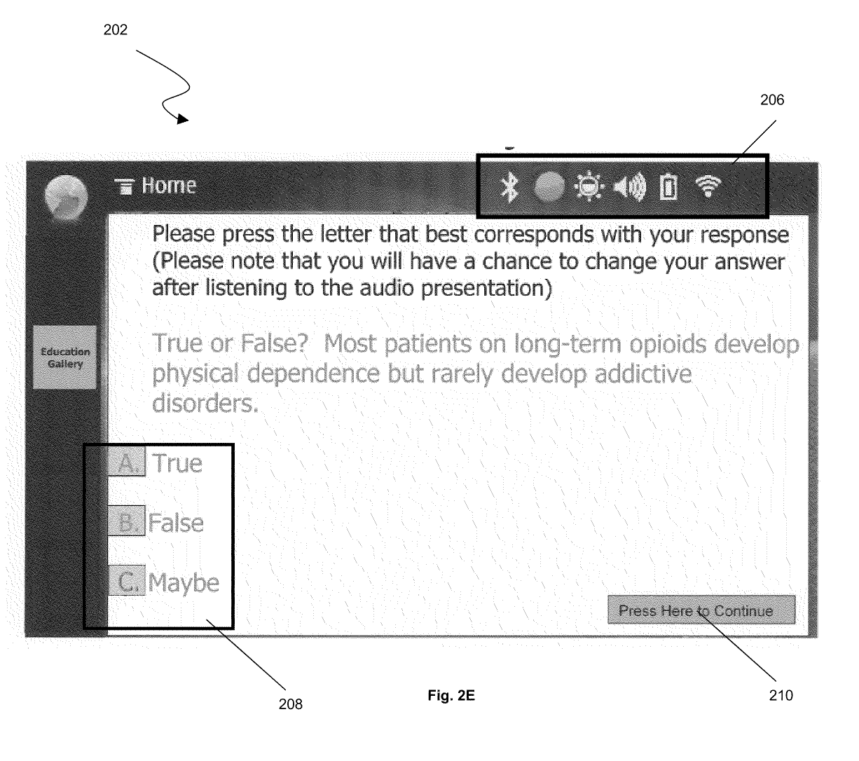

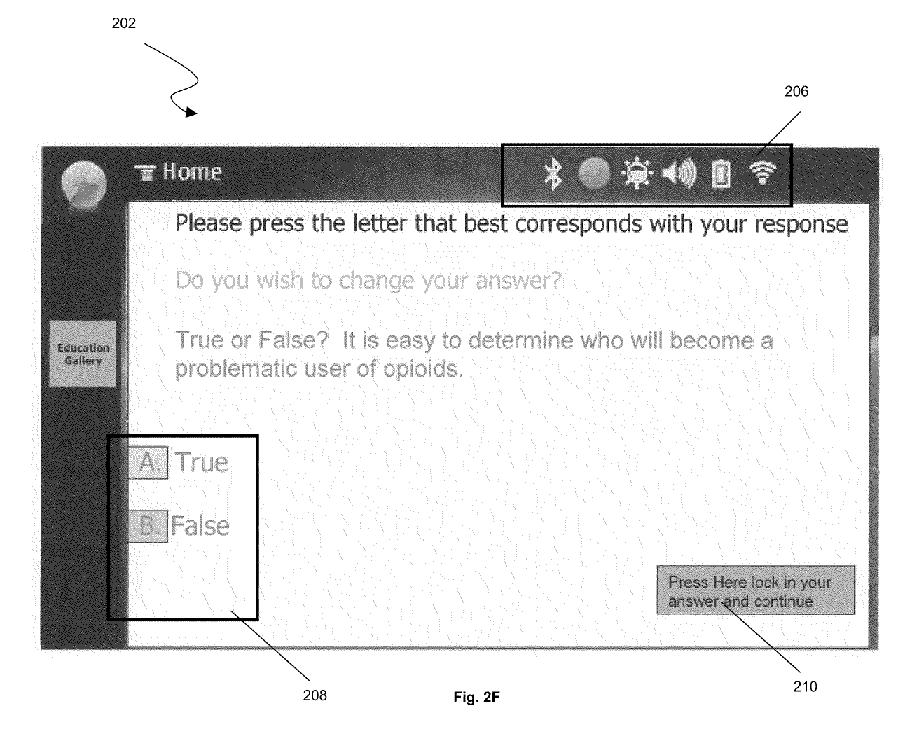

As noted above, a multimedia interactive guide is provided that includes one or more interactive handheld multimedia digital educator devices 106. FIGS. 2A, 2B and 2C illustrate example devices 106a-c configured in various formats. Device 106 is preferably configured for providing multimedia output, such as audio and visual output, as well as for receiving information provided from a user (e.g., via user-based input controls) and/or from another computing device over a communication network. Interactive handheld multimedia digital educator device 106 may be provided in a plurality of formats, including a display (e.g., color touch screen), communication device (e.g., radio frequency transceiver), audio output (speaker/earphones), and an input device (e.g., touchpad and physical and/or virtual keyboard) to guide a participant through the learning experience and to collect data during the learning process.

Audio content provided on device 106 may be presented by experts to lead the participant through the educational presentation, and may be interspersed with interactive questions and relevant video, charts, graphs or the like. Moreover, digital media may be interspersed with interactive questions during live and/or simulated teaching rounds. Device 106 may also provide simulated digital medical records interspersed with interactive questions to guide live patient diagnosis and management sessions. In at least one embodiment, participants travel through digitally enhanced learning center 100 to at least one scientific panel, and are presented with an audio, video, and/or image presentation that teaches practical skills, e.g., the “clinical pearls,” via device 104. An audio narrative functions at least partly to keep the participant's attention focused on the topic at hand, and provides various content in a relevant and meaningful context.

In an embodiment, one or more devices 106 maintain an active communication session with at least one user workstation 108 (or information processor 402, FIG. 4) during a learning session. During the session, content may be provided to device 106 from user workstation 108 that is selected to maintain the context of the session. Responses to questions, for example, are analyzed and relevant content is selected from the user workstation 108 and provided to the device 106. In various embodiments, user overrides may or may not be provided with device 106 to enable or prevent a participant from operating device 106 in an automated fashion.

FIGS. 2D-2F illustrate example screen displays 202 provided on devices 106 during a learning session. In FIG. 2D, video content presents three experts providing information. In the example shown in FIGS. 2D-2F, graphical screen controls are provided, such as to enable a user to control how content is presented and to submit information. For example, video controls 204 shown in FIG. 2D enable a user to restart video content at the beginning or pause content shown in section 205. Status displays 206 graphically display information regarding device 106, including the status of a BLUETOOTH connection, the brightness of the display, the volume level of the device 106, the battery level of device 106 and whether a Wi-Fi signal is presently used.

FIG. 2E illustrates an example screen display 202 provided on device 106 for a user to respond to a question. Answer controls 208 enable a user to select True, False or Maybe in response to a question posed on the device 106. Button control 210, when selected, enables a user to continue with the learning session. FIG. 2F illustrates another example screen display 202 provided on device 106 for a user to respond to a question. Unlike control 210 shown in FIG. 2E, however, control 210 in FIG. 2F enables a user to “lock in” the answer submitted in control 208, thereby precluding the user from changing the answer. In the examples shown in FIGS. 2E and 2F, a user is provided with an opportunity to respond to a question, and then change the response before locking in the answer, more permanently.

In an embodiment, a participant pre-registers by supplying information about the participant, such as demographic information, professional skills-related information and information regarding the participant's education history. In an embodiment, the participant initially logs into an Internet web site and supplies information that is stored for future reference. By receiving information about a particular participant in advance of a program, interactive digitally enhanced learning center 100 can provide custom content for the participant and can track the participant's learning progress over time. When the user uses device 106, the content is preferably configured at least partially in a customized and personally tailored way.

As noted above, prior to learning about a topic via display panels 104 and device 106, participants answer one or more questions about the topic. The information supplied by participants during this phase provides an initial baseline of the participant's understanding or knowledge of the topic. Thereafter, the participant goes through the training process, including via display panels 104 and device 106, and upon completion of one or more topics, the participant answers one or more questions, which may be the same or different questions as initially answered about the topic. A comparison may be made of answers to the initially answered questions and the answers given following instruction in order to measure the effectiveness of the participant's experience. Further, participants can view a comparison or evaluation to assess his/her current practice skills and the need for improvement thereof Further, as participants learn and are better able to answer topical questions, follow-up and/or more detailed questions may be posed to the participants.

In one embodiment, interactive digitally enhanced learning center 100 assesses responses that participants give to initial questions regarding a topic, prior to the participant proceeding with viewing display panels 104 and interacting with device 106. Based on the assessment of the participant's then current skill level (as represented by the participant's responses), specific content may be selected to be shown and described to the participant on display panels 104 and device 106. For example, a participant may be beginning a topic on lung disease. If the participant correctly answers questions, including possible follow-up questions, center 100 may select more advanced questions, such as relating to esoteric lung disease material. Thus, the content shown and described on panels 104 and devices 106 may be dynamically provided depending upon one or more criteria, including as set forth by participants. Other sources of information may govern particular content shown and described to participants via display panels 104 and device 106, such as pre-registration information and responses to interactive prompts, as participants are taught information via display panels 104 and device 106.

In an embodiment, participants work through education gallery 102 during a period of time, such as 15-20 minutes, as they view panels 104 and respond to prompts provided on interactive via device 106. It may be preferable to enforce time limits on participants due to scheduling or other concerns. Alternatively, it may be preferable to let participants have a flexible amount of time to view and learn about content provided on display devices 104 and device 106. In either case, a goal of the teachings herein is to engage people and to ensure that participants learn subject matter more thoroughly than would otherwise be possible in the prior art.

Interactive digitally enhanced learning center 100 is an effective way to educate primary care physicians (PCP's) and other healthcare professionals. Interactive digitally enhanced learning center 100 may provide information in a certified CME format to meet the educational needs of today's clinicians by providing participants an opportunity to actively assess and enhance their practice skills as those skills relate to various disease states. Center 100 includes at least in part an expert-guided, self directed, interactive learning experience that provides a scientific presentation coupled with live patient, peer-to-peer, and expert interaction. Outcome data are captured throughout the learning experience to assess immediate change in participant behavior.

Interactive digitally enhanced learning center 100 certified CME/CE activity provides primary care physicians and other healthcare professionals with an opportunity to enhance their knowledge with regard to the management of patients with conditions and dysfunctions. In connection with a medically related CME/CE, and based upon a review of the disease state and result of needs assessment, an educational initiative with the following learning objectives is provided. For example, upon completion of this activity, participants are able to describe the epidemiology of a particular condition or dysfunction and understand the prevalence thereof. Moreover, participants are educated to use one or more screening tools to rapidly identify the condition, and participants are also able to differentiate a particular disorder or condition from another, potentially similar one. Other skills that participants may gain as a function of the teachings herein include an ability to develop confidence in their abilities to characterize and treat a particular condition/disorder, to engage in respectful and productive conversation with patients regarding medical conditions, and to recognize and compare the neurobiological basis of current and investigational interventions for the treatment of particular conditions and/or dysfunctions. Accordingly, interactive digitally enhanced learning center 100 provides physicians and allied healthcare professionals with an opportunity to enhance their knowledge and skills for diagnosing, counseling, and managing patients.

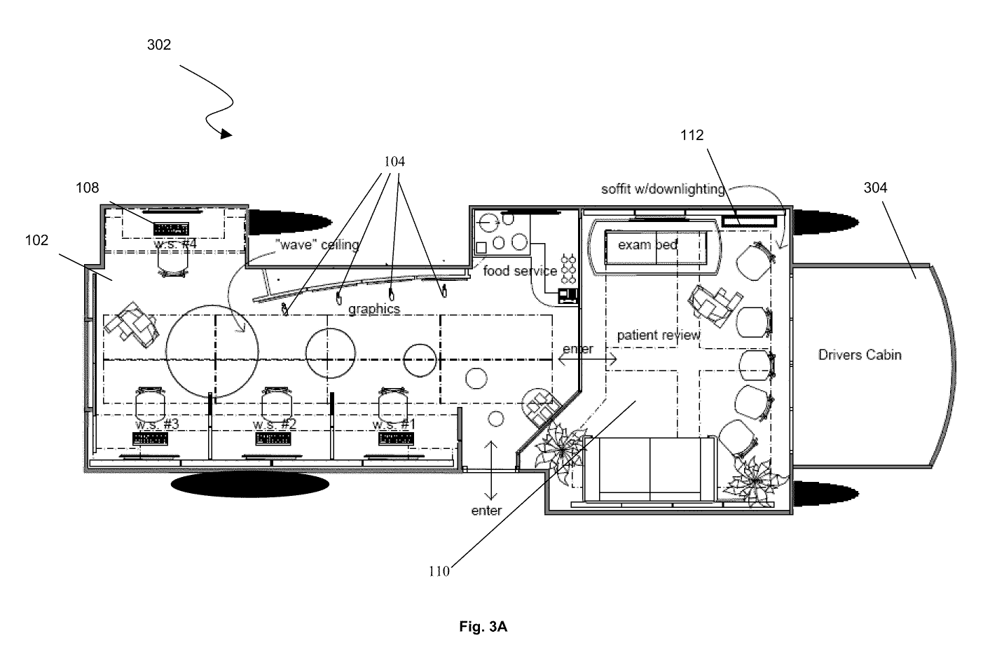

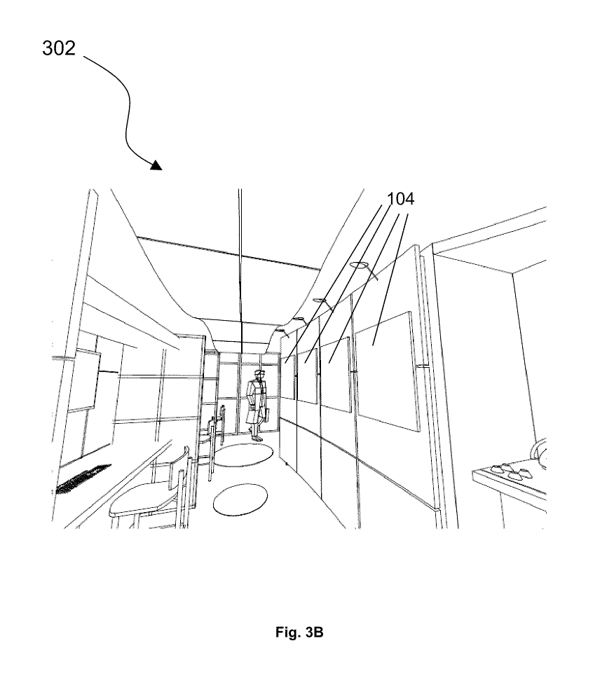

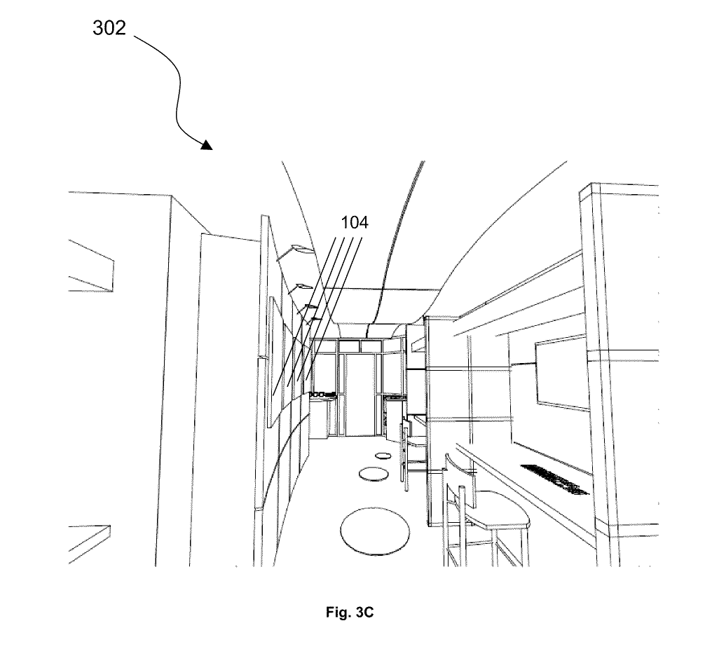

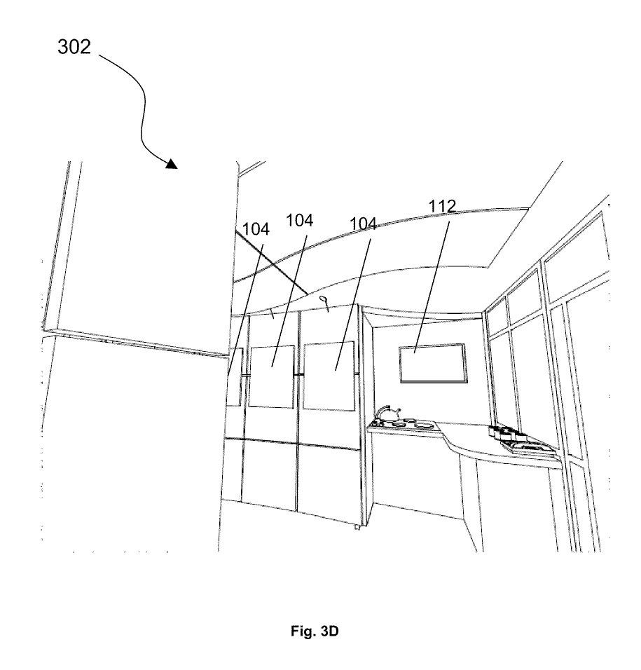

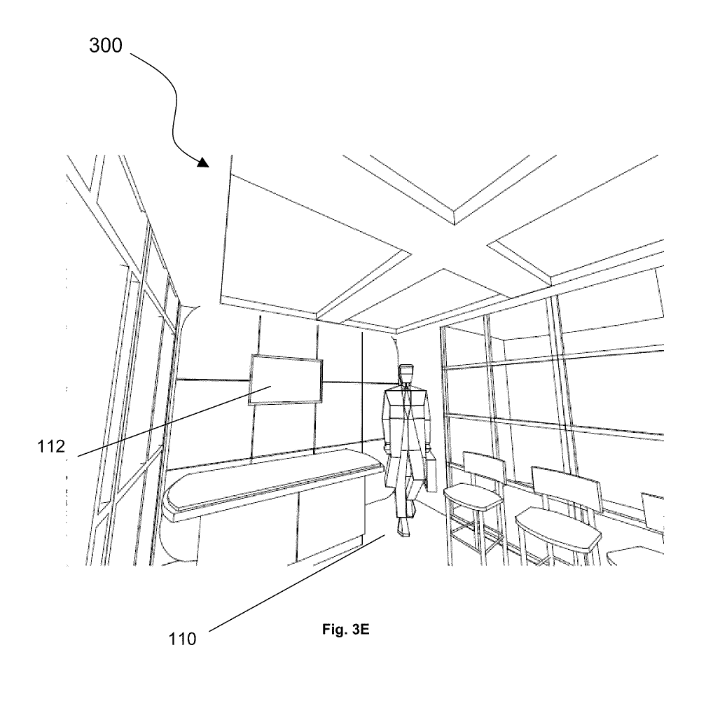

Although many of the embodiments and examples described herein regard an interactive digitally enhanced learning center 100 that is provided, for example, in a convention hall, hotel or other public meeting place, the invention is not so limited. In an alternative embodiment, a mobile unit, such as a RV or a van is configured as an interactive digitally enhanced learning center 100. FIGS. 3A-3E illustrate an example interactive digitally enhanced learning center 100 that is provided in a mobile learning center 302, and configured generally as a bus. In this way, learning center 100 can be driven from place to place, and precludes a need for users to travel distances (potentially long distances) to reach learning center 100 and be availed of the teachings herein.

FIG. 3A is a top plan view of an example mobile learning center 302 that includes interactive educational gallery 102, displays 104, diagnosis/treatment area 110 and display screen 112. Mobile learning center 302 further comprises driver's cabin 304 for users to drive mobile learning center 302 from place to place.

FIG. 3B illustrates a rear view of the interior of an example embodiment of mobile learning center 302, and includes display panels 104, which provide content that is synchronized with a multimedia interactive guide substantially as described above. FIG. 3C illustrates a front view of the interior of the example mobile learning center 302 shown in FIG. 3B. FIG. 3D illustrates a right view of the interior of the example mobile learning center 302 shown in FIGS. 3B and 3C.

FIG. 3E illustrates another view of the interior of an example embodiment of mobile learning center 302, and illustrates diagnosis/treatment area 110 where participants engage in the diagnosis and treatment management of patient(s). As described above with reference to FIG. 1D, example treatment area 110 provides a location for replicating real-world experiences of a clinician.

Thus and as illustrated in FIGS. 3A-3E, mobile learning center 302 is configured to provide much (if not all) of the same interactivity and learning opportunity as described above in connection with learning center 100. Preferably, mobile learning center 302 is configured to maintain communication sessions over a communication network, such as the Internet, and to receive dynamically send and receive content, such as described in connection with learning center 100.

FIG. 4 shows an example hardware arrangement in accordance with an embodiment. In the embodiment shown in FIG. 4, at least one information processor or server 402 that is operatively coupled to database 404 and that preferably manages or is configured to monitor data. Information processor 402 is preferably configured to operate as an Internet web server, and to provide a website that is remotely accessible to learning centers 100 and 302. Moreover, tools and/or resources are preferably provided by information processor 402 to be presented and/or discussed for participants, such as via gallery 102. For example, electronic copies of material shown on display panels 104, audio content provided by experts, and/or transcripts of discussions with participants is available via the Internet web site. In one embodiment, participants receive a hyperlink to the web site, such as via an email message, which provides secured access to the content stored thereon. In a longitudinal curriculum, which may be provided subsequent to a live learning experience, participants continue to receive resources and CME/CE opportunities. Participants may also receive a follow up survey to chart their progress and provide feedback regarding the overall learning experience.

Information processor 402 is preferably configured to access communication network 406, and to communicate with centers 100 and 302, including one or more of the various devices associated therewith, including mobiles devices 106. Information processor 402 may further be configured to operate as a hypertext transport protocol (“HTTP”) Internet web server and/or a file transfer protocol (“FTP”) server to send and receive information, and to access and update database 404.

Preferably, information processor 402 and devices associated with learning center 102 communicate via the known communications protocol, Transmission Control Protocol/Internet Protocol (“TCP/IP”). In this way, content can be transmitted to and from the devices and commands can be executed to enable various kinds of functionality described herein. Information processors 402 and computing devices 106 are, depending on their configurations, any devices that are capable of sending and receiving data across communication network 406, including, for example, mainframe computers, mini computers, personal computers, laptop computers, netbook computers, personal digital assistants (PDA), mobile communication devices such as telephones and internet access devices. In addition, information processor 102 and computing devices 104, 106 may be equipped with one or more internet web browsers, such as MICROSOFT INTERNET EXPLORER, MOZILLA FIREFOX, SAFARI or the like. Thus and as envisioned herein, information processor 402 and/or computing devices 106/108 are devices that can communicate over a network and can be operated anywhere, including, for example, from vehicles.

In a preferred embodiment, various kinds of input and output devices are utilized in system 100. Although many of the devices interface (e.g., connect) with a computer, it is envisioned herein that many of the devices can operate without any direct connection to a computer. Moreover, various so-called “peripheral” devices may be included in system 100 including, for example, imaging equipment (e.g., cameras), voice recording equipment and global positioning system (“GPS”) technology. Such peripheral devices may also send and receive data to and from information processor 402 and/or computing devices 106/108.

The nature of the present invention is such that one skilled in the art of writing computer executable code (i.e., software) can implement the described functions using one or more of a combination of popular computer programming languages and development environments including, but not limited to C, C++, Visual Basic, JAVA, PHP, HTML, XML, ACTIVE SERVER PAGES, JAVA server pages, servlets, MICROSOFT.NET, and a plurality of various web site development applications.

For example, data may be configured in a MICROSOFT EXCEL spreadsheet file, as a comma delimited ASCII text file, as a MICROSOFT SQL SERVER compatible table file (e.g., MS-ACCESS table), or the like. In another embodiment, data may be formatted as an image file (e.g., TIFF, JPG, BMP, GIF, or the like). In yet another embodiment, data may be stored in an ADOBE ACROBAT PDF file. Preferably, one or more data formatting and/or normalization routines are provided that manage data received from one or more of a plurality of sources. In another example, data are received that are provided in a particular format (e.g., MICROSOFT EXCEL), and programming routines are executed that convert the data to another format (e.g., ASCII comma-delimited text).

It is contemplated herein that any suitable operating system can be used on information processor 402 and computing devices 106, 108 and, may be, for example, DOS, WINDOWS 3.x, WINDOWS 95, WINDOWS 98, WINDOWS 2000, WINDOWS VISTA, WINDOWS XP, WINDOWS 7, WINDOWS NT, MAC OS, UNIX, LINUX, PALM OS, POCKET PC, BLACKBERRY or any other suitable operating system. Further, the teachings herein support various programming languages and/or software development environment environments, such as JAVA, JAVA Script, Action Script, Swish, or the like. Moreover, a plurality of data file types is envisioned herein. For example, the present invention preferably supports various suitable multi-media types, including but not limited to JPEG, BMP, GIF, TIFF, MPEG, AVI, MP4, SWF, RAW or the like (as known to those skilled in the art).

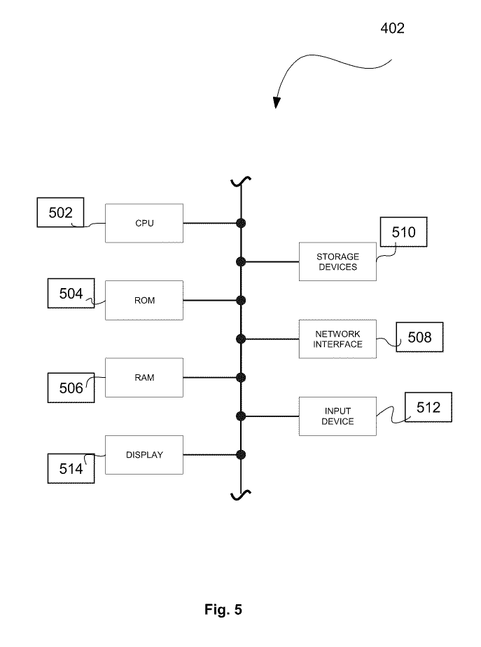

FIG. 5 illustrates the functional elements of an information processor 402 and/or computing devices 106, 108 which typically include one or more central processing units (CPU) 502 used to execute software code and control the operations of the devices, read-only memory (ROM) 504, random access memory (RAM) 506, one or more network interfaces 508 to transmit and receive data to and from other computing devices across the communication network, storage devices 510, such as a hard disk drive, floppy disk drive, tape drive, CD ROM, flash or other electronic memory, or other memory for storing program code, databases, application data and other data, one or more input devices 512 such as a keyboard, mouse, track ball, touch pad, touch screen, microphone, camera or the like, and a display 514.

The various components of information processor 502 and/or computing devices 106, 108 need not be physically contained within the same chassis or even located in a single location. For example, storage location 10 may be located at a site that is remote from the remaining elements of information processor 402, and may even be connected to CPU 502 across communication network 406 via network interface 508. Information processor 402 preferably includes a memory equipped with sufficient storage to provide the necessary databases, forums, and other services, as well as acting as a web server for communicating hypertext markup language (HTML), FLASH, Action Script, Java, Active Server Pages, Active-X control programs to computing devices 106, 108. Information processor 402 is preferably arranged with components, for example, those shown in FIG. 5, that are suitable for the expected operating environment of information processor 402. The CPU(s) 502, network interface(s) 508 and memory and storage devices are selected to ensure that the capacities are arranged to accommodate expected demand.

In an embodiment, client software is distributed and installed on one or more mobile computing devices 106, such as smart phones (e.g., BLACKBERRY, IPHONE, DROID or the like), personal digital assistants, or other mobile devices that can be carried by persons. In an embodiment, a person connects to a web site or other software distribution site, such as provided via information processor 402, and downloads a copy of the client software application to be installed on mobile device 106. In an alternative embodiment, the client software application is pre-installed on a mobile device 106/user workstation 108 and distributed thereafter to operate with centers 100/302.

In addition and as noted herein, a valuable feature of the teachings herein includes development and distribution of outcome data, which represents the impact of educational activities and programs through a variety of quantitative outcomes measurements. In an embodiment, information processor 402 receives data from galleries 102 and/or devices 106,108, and uses the data to generate outcome data. Outcome data, including measurements, may be custom-designed for respective educational activities, based upon the activity goals, format, and budget, as well as to address particular outcome levels. For example, participation outcome data may be provided that are based upon a rate of program completion and subsequent certification relative to topics provided by centers 100, 302. Other outcome data may relate to activity response, for example, for participation and/or completion rates. In addition, outcome data may be provided that relates to participants' ratings of program satisfaction, such as for topics covered, the quality of information presented, the format of activities, the level of complexity and whether program objectives were met.

Other kinds of outcome data that may be provided in accordance with the teachings herein include participants' ability to achieve educational objectives in both the short and long terms, as well as participants' descriptions of anticipated activity impact on their patient care management. Moreover, performance outcome data may be provided that are based upon participants' self-reporting regarding the impact the program has had on daily patient care management skills, based upon feedback regarding examples of skills that participants have utilized as a result of their learning, as well as demonstrated practice with simulated and/or actual patients, both live and online.

The table below identifies continuing medical education and performance improvement outcomes technology as a function of centers 100, 302:

| | |
|---|---|
| Pre-evaluation | Assesses learners' performance-in- |
| | practice in regard to a particular patient |
| | population |
| Interactive disease management | Presents relevant pathophysiology, |
| education delivered by experts | therapeutic, and management |
| through a Digital Educator | information |
| | Asks key questions throughout |
| | learning process |
| | Provokes consideration of |
| | practitioner's patient population |
| | Evalutes current management strategies |
| | Provides immediate feedback regarding |
| | optimal treatment strategies |
| Live patient care scenarios | Provides patient perspective, expert |
| | commentary, and peer-to-peer exchange |
| | Engages practitioners at various levels |
| | of experience |
| | Incorporates and supports |
| | implementation of guidelines and/or |
| | evidence-based expert consensus |
| Rich outcomes data generated | Demographic data relevant to |
| via measurements gathered | practitioner and his/her patient |
| during Teaching Rounds | population |
| | Diagnostic decisions |
| | Therapeutic and management choices |
| | Patient counseling and follow up |
| | conclusion |
| Ongoing data collection | Further outcomes may be captured via |
| | optional online virtual patient |
| | assessment activities |

In an embodiment, various kinds for evaluation are envisioned for a plurality of purposes. For example, a pre-evaluation form captures information related to demographics and practice, as well as to assess current knowledge. The on-site evaluation obtains participants' feedback regarding execution of an activity, as well as to capture: 1) the level of participant satisfaction with the overall activity (i.e., format, content), 2) the level of knowledge or skill acquired through participation (i.e., activity achievement of learning objectives), 3) the anticipated effect on practice including barriers to change, and 4) future educational needs and interests. Moreover, evaluation is provided to assess performance outcomes, including a follow up post-event survey that may be sent to all participants six to eight weeks after a program event to assess implementation and/or barriers to change in practice. Moreover activity data will be preferably collected prior to, during and after a program that are analyzed to measure and demonstrate the impact of systems' 100, 302 education on participant's knowledge and performance. Activity evaluation may also be attained through an analysis of the number in attendance and the number of CME certificates issued.

In addition and following an activity, information may be provided in one or more reports and may be published in monographs. Data, such as described above, are captured and analyzed to produce report(s) relating to educational outcomes. In addition as part of an educational curriculum, outcomes data from this activity will be included in a CME supplement that reports the educational experiences of a longitudinal series of CME activities. Practitioners preferably review published material following educational activities in accordance with the teachings herein.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A method for providing interactive education, the method comprising:
storing, on one or more processor media that are operatively coupled to one or more processors, at least one database including:
electronic user information representing a plurality of respective persons,
electronic educational content information including instructive materials associated with at least one topic, and
electronic testing information including at least one question associated with the at least one topic;
providing an education gallery that is configured with at least one computing device that is operatively connected to the one or more processors;
providing at least one panel with the education gallery, wherein the at least one panel at least provides information associated with the educational content information;
receiving from a first user computing device associated with a first user, via the one or more communication devices, first electronic user information representing the first user;
selecting, by the one or more processors and based on at least the first user information:
first electronic educational content information from the electronic educational content information stored in the database and that is associated with a first of the at least one topic; and
first electronic testing information from the electronic testing information stored in the database and that is associated with the first of the at least one topic;
sending to the first user computing device, via the one or more communication devices, the first electronic educational content information and the first electronic testing information; and
receiving from the first user computing device, via the one or more communication devices, at least one response to at least one question associated with the first electronic testing information.

2. The method of claim 1, wherein the first electronic educational content information corresponds with content provided by the at least one panel.

3. The method of claim 1, wherein the first electronic educational content information includes multi-media content.

4. The method of claim 1, wherein at least some of the first electronic testing information is provided on the first user computing device after the first electronic educational content is provided on the first user computing device.

5. The method of claim 1, further comprising:
selecting, by the one or more processors and based on at least the first user information:
second electronic educational content information from the electronic educational content information stored in the database and that is associated with a second of the at least one topic; and
second electronic testing information from the electronic testing information stored in the database and that is associated with the second of the at least one topic;
sending to the first user computing device, via the one or more communication devices, the second electronic educational content information and the second electronic testing information; and
receiving from the first user computing device, via the one or more communication devices, at least one other response to at least one other question associated the second electronic testing information.

6. The method of claim 1, further comprising:
receiving from the first user computing device, via the one or more communication devices, a second electronic response to at least one question associated with the first electronic testing information, wherein the at least one question is provided prior to the user viewing the first electronic educational content information;
determining, by the one or more processors and based on at least the second electronic response, a first level of understanding for the first user of the first of the at least one topic;
determining, by the one or more processors and based on at least the first electronic response, a second level of understanding for the first user of the first of the at least one topic, wherein the first electronic response is received after the second electronic response;
comparing the first level of understanding and the second level of understanding;
selecting, by the one or more processors and based at least on the comparing, one of:
second electronic testing information for the first of the at least one topic; and
at least one of second electronic educational content and second electronic the testing information for a second of the at least one topic;
sending to the first user computing device, via the one or more communication devices, one or more of the second electronic educational content and the second electronic testing information; and
receiving from the first user computing device, via the one or more communication devices, at least one other response to at least one other question associated the second electronic testing information.

7. The method of claim 1, wherein the at least one topic represents medical information.

8. The method of claim 1, wherein the at least one panel displays information received from the one or more processors.

9. The method of claim 8, wherein the first electronic educational information is displayed on the first user computing device while the at least panel displays the information received from the one or more processors.

10. A method for providing interactive education, the method comprising:
storing, on one or more processor media that are operatively coupled to one or more processors, at least one database including:
electronic user information representing a plurality of respective persons,
electronic educational content information including instructive materials for at least one topic;
electronic testing information including at least one question associated with the at least one topic;
receiving, via one or more communication devices that are operatively connected to the one or more processors and from a first user computing device associated with a first user, first electronic user information representing the first user;
selecting, by the one or more processors and based on at least the first user information, first electronic educational content information from the electronic educational content information stored in the database for a first of the at least one topic;
selecting, by the one or more processors, first electronic testing information from the electronic testing information stored in the database for the first of the at least one topic;
transmitting to the first user computing device, via the one or more communication devices, the first electronic testing information;
receiving from the first user computing device, via the one or more communication devices, a first electronic response to at least one question associated with the first electronic testing information;
determining, by the one or more processors and based on at least the first electronic response, a first level of understanding for the first user of the first of the at least one topic;
selecting, by the one or more processors, second electronic testing information from the electronic testing information stored in the database for the first of the at least one topic or a second of the at least one topic;
transmitting, via the one or more communication devices to the first user computing device, the first electronic educational content and the second electronic testing information;
receiving, via the one or more communication devices and from the first user computing device, a second electronic response to at least one question associated with the second electronic testing information;
determining, by the one or more processors and based on at least the second electronic response, a second level of understanding for the first user of the first of the at least one topic;
comparing the first level of understanding and the second level of understanding;
selecting, by the one or more processors and based at least on the comparing, one of:
at least one of second electronic educational content and third electronic testing information for the first of the at least one topic; or
at least one of second electronic educational content and third electronic testing information for a second of the at least one topic; and
transmitting, via the one or more communication devices to the first user computing device, the second electronic educational content and the third electronic testing information.

11. The method of claim 10, wherein at least one of the first electronic educational content and the second educational content includes audio-visual content.

12. A system for providing interactive education, the system comprising:
one or more processor media that are operatively coupled to one or more processors;
one or more communication devices operatively coupled to the one or more processors;
at least one database stored on the one or more processor readable media that includes:
electronic user information representing a plurality of respective persons,
electronic educational content information including instructive materials associated with at least one topic, and
electronic testing information including at least one question associated with the at least one topic;
an education gallery that is configured with at least one computing device and that is operatively connected to the one or more processors;
at least one panel provided with the education gallery, wherein the at least one panel at least provides information associated with the educational content information; wherein the one or more processors are programmed and configure to:
receive from a first user computing device associated with a first user, via the one or more communication devices, first electronic user information representing the first user;
select, based on at least the first user information:
first electronic educational content information from the electronic educational content information stored in the database and that is associated with a first of the at least one topic; and
first electronic testing information from the electronic testing information stored in the database and that is associated with the first of the at least one topic;
send to the first user computing device, via the one or more communication devices, the first electronic educational content information and the first electronic testing information; and
receive from the first user computing device, via the one or more communication devices, at least one response to at least one question associated with the first electronic testing information.

13. The system of claim 12, wherein the first electronic educational content information corresponds with content provided by the at least one panel.

14. The system of claim 12, wherein the education gallery is provided in a vehicle.

15. The system of claim 12, wherein at least some of the first electronic testing information is provided on the first user computing device after the first electronic educational content is provided on the first user computing device.

16. The system of claim 12, wherein the one or more processors are further programmed and configured to:
select, based on at least the first user information:
second electronic educational content information from the electronic educational content information stored in the database and that is associated with a second of the at least one topic; and
second electronic testing information from the electronic testing information stored in the database and that is associated with the second of the at least one topic;
send to the first user computing device, via the one or more communication devices, the second electronic educational content information and the second electronic testing information; and
receive from the first user computing device, via the one or more communication devices, at least one other response to at least one other question associated the second electronic testing information.

17. The system of claim 12, wherein the one or more processors are further programmed and configured to:
receive from the first user computing device, via the one or more communication devices, a second electronic response to at least one question associated with the first electronic testing information, wherein the at least one question is provided prior to the user viewing the first electronic educational content information;
determine, based on at least the second electronic response, a first level of understanding for the first user of the first of the at least one topic;
determine, based on at least the first electronic response, a second level of understanding for the first user of the first of the at least one topic, wherein the first electronic response is received after the second electronic response;
compare the first level of understanding and the second level of understanding;
select, based at least on the comparing, one of:
second electronic testing information for the first of the at least one topic; and
at least one of second electronic educational content and second electronic the testing information for a second of the at least one topic;
send to the first user computing device, via the one or more communication devices, one or more of the second electronic educational content and the second electronic testing information; and
receive from the first user computing device, via the one or more communication devices, at least one other response to at least one other question associated the second electronic testing information.

18. The system of claim 12, wherein the at least one topic represents medical information.

19. The system of claim 12, wherein the at least one panel displays information received from the one or more processors.

20. The system of claim 19, wherein the first electronic educational information is displayed on the first user computing device while the at least panel displays the information received from the one or more processors.
